(19) United States
(12) Patent Application Publication
(10) Pub. No.: US 2025/0300383 A1
(43) Pub. Date: Sep. 25, 2025

(54) POWER CONNECTOR AND POWER CONNECTOR ASSEMBLY

(71) Applicant: Bellwether Electronic Corp., Taoyuan City (TW)

(72) Inventor: Yung-Liang CHI, Taoyuan City (TW)

(21) Appl. No.: 19/064,751

(22) Filed: Feb. 27, 2025

Related U.S. Application Data
(60) Provisional application No. 63/566,922, filed on Mar. 19, 2024.
(60) Provisional application No. 63/649,470, filed on May 20, 2024.

(30) Foreign Application Priority Data
Nov. 25, 2024 (TW) 113145377

(51) Int. Cl. H01R 13/40; H01R 13/627; H01R 13/629

(52) U.S. Cl. CPC H01R 13/40; H01R 13/627; H01R 13/629

(57) ABSTRACT

A power connector assembly includes a first and a second connector. The first connector includes a first housing having a slot, a detection terminal disposed on one side of the slot, and multiple power terminals. The power terminals are divided into two sets disposed on two sides of the slot, respectively. The second connector includes a second housing, a cable assembly and a mating member. The mating member includes two cable-end terminals provided on two faces of the mating member and electrically isolated from each other. The second housing has a mating chamber for receiving the first connector. The mating member is located in the mating chamber and is configured to be inserted into the slot of the first connector for contacting the detection and power terminals. The cable assembly is electrically connected to the mating member and extends out of the second housing.

### RELATED APPLICATIONS

This application claims priority to U.S. Provisional Application Ser. No. 63/566,922, filed Mar. 19, 2024, U.S. Provisional Application Ser. No. 63/649,470, filed May 20, 2024, and Taiwan Application Serial Number 113145377, filed Nov. 25, 2024, the disclosures of which are incorporated herein by reference in their entireties.

### BACKGROUND

### Technical Field

The present disclosure relates to a power connector and a power connector assembly.

### Description of Related Art

As technology advances, computer servers have increasingly higher demand for electric power. Therefore, the industry is in urgent need of a solution for improving power connectors such that they can carry larger electric current, dissipate heat at higher rate and have a compact size.

### SUMMARY

In view of the foregoing, one of the objects of the present disclosure is to provide an improved power connector and an improved power connector assembly to resolve the technical problem mentioned above.

In accordance with an embodiment of the present disclosure, a power connector assembly includes a first power connector and a second power connector. The first power connector includes a first insulative housing, at least one detection terminal and a plurality of power terminals. The first insulative housing has a slot. The power terminals are divided into two sets disposed on two sides of the slot, respectively. Each of the power terminals includes at least one elastic arm exposed in the slot. The detection terminal is disposed on at least one of the two sides of the slot. The second power connector includes a second insulative housing, a cable assembly and a mating member. The mating member includes two cable-end terminals provided on two faces of the mating member, respectively, and electrically isolated from each other. The second insulative housing has a mating chamber configured to receive the first power connector. The mating member is located in the mating chamber and is configured to be inserted into the slot of the first power connector and make contact with the detection terminal and the power terminals of the first power connector. The cable assembly is electrically connected to the mating member and extends out of the second insulative housing.

In one or more embodiments of the present disclosure, each of the power terminals includes a leg portion. The leg portion includes a plurality of tails. The tails of the power terminals of each of the two sets are arranged into multiple rows.

In one or more embodiments of the present disclosure, the first insulative housing has a mating portion configured to be inserted into the mating chamber. A lateral surface of the mating portion is provided with a guiding strip. The guiding strip extends along a mating direction of the first power connector and the second power connector. The second insulative housing has a guiding groove configured to receive the guiding strip.

In one or more embodiments of the present disclosure, a front edge of the mating member has a notch. The notch is at a position corresponding to the detection terminal.

In one or more embodiments of the present disclosure, the mating member further includes a terminal spacer disposed between the two cable-end terminals.

In one or more embodiments of the present disclosure, the terminal spacer includes a projecting rim covering front edges of the two cable-end terminals. The projecting rim has at least one chamfer.

In one or more embodiments of the present disclosure, the second insulative housing includes a main body and a latch. The main body has the mating chamber. The latch is disposed on a side of the mating chamber and is configured to interlock with the first insulative housing.

In one or more embodiments of the present disclosure, the second power connector further includes a pull tape connected to the latch.

In one or more embodiments of the present disclosure, the main body further has a side opening communicating with the mating chamber. The latch is positioned to face the side opening. The main body further includes a guarding wall partially covering the side opening and the latch.

In one or more embodiments of the present disclosure, the power terminals include a first power terminal and a second power terminal each having a contact region. The contact region is located on the elastic arm. The contact region of the first power terminal and the contact region of the second power terminal are substantially coplanar.

In one or more embodiments of the present disclosure, the detection terminal has a first contact region. Each of the power terminals has a second contact region. A distance from the first contact region to an entrance of the slot is greater than a distance from the second contact region to the entrance of the slot.

In accordance with an embodiment of the present disclosure, a power connector includes an insulative housing and a plurality of terminals. The insulative housing has a slot. The terminals are disposed in the insulative housing and are partially exposed in the slot. The terminals include at least one detection terminal and a plurality of power terminals. Each of the power terminals includes a leg portion, and the leg portion includes a plurality of tails. The power terminals are divided into multiple power terminal sets. For each power terminal set, the tails of the power terminals are arranged into multiple rows.

In accordance with an embodiment of the present disclosure, a power connector includes an insulative housing, a mating member and a cable assembly. The insulative housing has a mating chamber for receiving another power connector. The mating member includes two cable-end terminals. The two cable-end terminals each include a contact portion and a cable connection portion. The contact portions of the two cable-end terminals are substantially planar, located in the mating chamber, and provided on two faces of the mating member, respectively. The cable assembly is connected to the cable connection portion of the two cable-end terminals and extends out of the insulative housing.

In sum, by virtue of the structural configurations described above, the power connector and the power connector assembly of the present disclosure can carry larger electric current and provide stable power supply, while maintaining a compact size.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates an assembled view of a power connector assembly in accordance with an embodiment of the present disclosure;

FIG. 2 illustrates an exploded view of the power connector assembly shown in FIG. 1;

FIG. 3 illustrates an axonometric view of the insulative housing of the board-end connector shown in FIG. 2;

FIG. 4 illustrates a top view of the board-end connector shown in FIG. 1;

FIG. 5 illustrates an exploded view of some components of the cable-end connector shown in FIG. 1;

FIG. 6 illustrates a sectional view of the power connector assembly shown in FIG. 1;

FIG. 7 illustrates an axonometric view of some components of the power connector assembly shown in FIG. 1;

FIG. 8 illustrates a sectional view of a power connector assembly in accordance with another embodiment of the present disclosure;

FIG. 9 illustrates a sectional view of a cable-end connector in accordance with another embodiment of the present disclosure;

FIG. 10 illustrates an axonometric view of a power connector assembly in accordance with another embodiment of the present disclosure;

FIG. 11 illustrates an axonometric view of the cable-end connector shown in FIG. 10;

FIGS. 12 and 13 each illustrate an axonometric view of some components of the cable-end connector shown in FIG. 11;

FIG. 14 illustrates an axonometric view of a power connector assembly in accordance with another embodiment of the present disclosure;

FIG. 15 illustrates an exploded view of some components of the cable-end connector shown in FIG. 14;

FIG. 16 illustrates an exploded view of the board-end connector shown in FIG. 14;

FIG. 17 illustrates an axonometric view of some components of the board-end connector shown in FIG. 14;

FIG. 18 illustrates an axonometric view of a power connector assembly in accordance with another embodiment of the present disclosure;

FIG. 19 illustrates an axonometric view of some components of the cable-end connector shown in FIG. 18;

FIG. 20 illustrates an axonometric view of a cable-end connector in accordance with another embodiment of the present disclosure;

FIG. 21 illustrates an exploded view of a board-end connector in accordance with another embodiment of the present disclosure, in which the board-end connector can mate with the cable-end connector shown in FIG. 20;

FIG. 22 illustrates an exploded view of a power connector assembly in accordance with another embodiment of the present disclosure;

FIG. 23 illustrates a sectional view of some components of the cable-end connector shown in FIG. 22; and

FIG. 24 illustrates an exploded view of a power connector assembly in accordance with another embodiment of the present disclosure.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

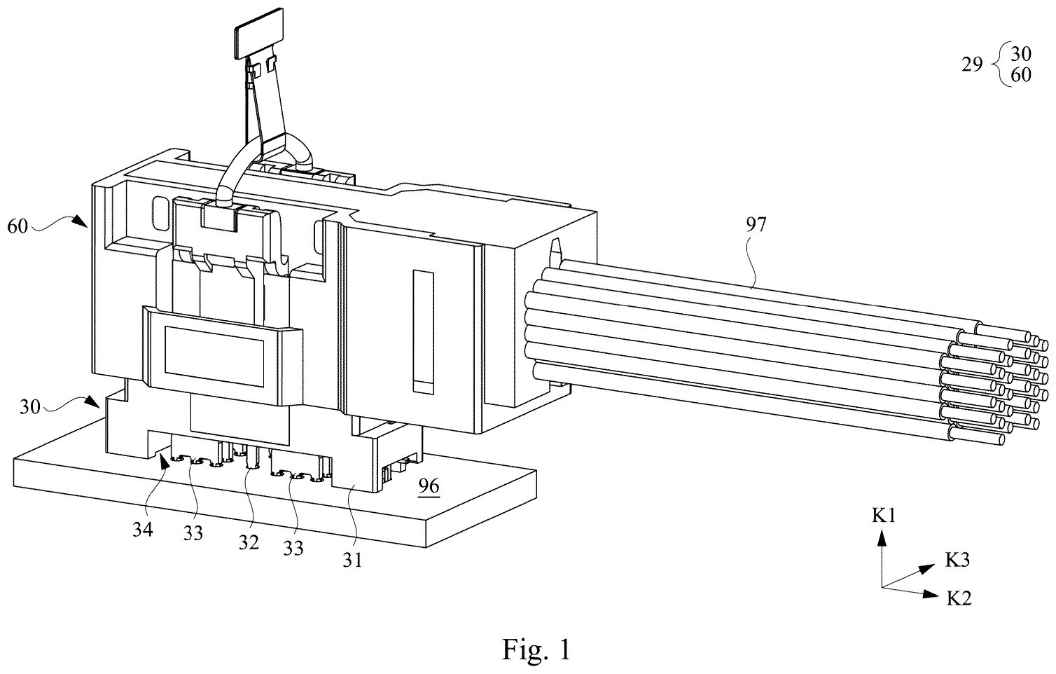

Reference is made to FIG. 1, which illustrates an assembled view of a power connector assembly 29 in accordance with an embodiment of the present disclosure. As shown, the power connector assembly 29 includes a board-end connector 30 and a cable-end connector 60. The board-end connector 30 is disposed on a circuit board 96, and the cable-end connector 60 is connected to one end of a cable assembly 97. The board-end connector 30 and the cable-end connector 60 can be mated to each other to enable delivery of electric power. In some embodiments, at least one electronic component (not depicted; may include at least one chip) is disposed on the circuit board 96 and is electrically connected to the board-end connector 30 via conductive traces provided on the surfaces or in the interior of the circuit board 96. Another end of the cable-end connector 60 is electrically connected to a power source. The power source can provide power to the electronic component via the cable assembly 97, the power connector assembly 29 and the circuit board 96. The board-end connector 30 of the present embodiment is a vertical-type connector, i.e., the board-end connector 30 is mounted upright on the circuit board 96, and its mating direction K1 is substantially normal to the circuit board 96. The power connector assembly 29 can be used by devices including but not limited to computer servers.

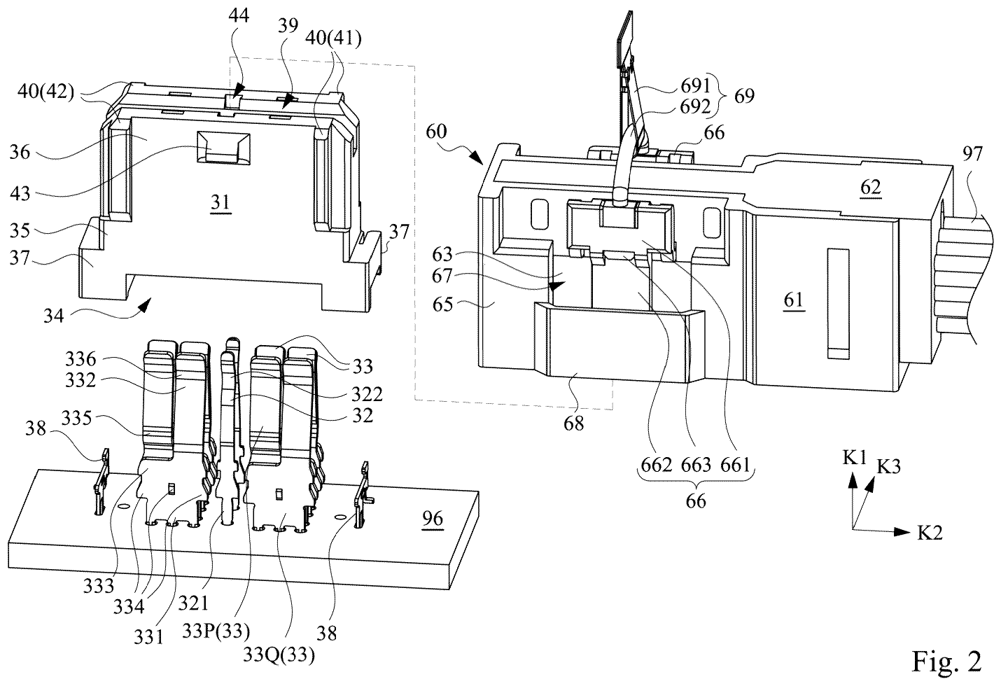

Reference is made to FIG. 2, which illustrates an exploded view of the power connector assembly 29 shown in FIG. 1. As shown, the board-end connector 30 includes an insulative housing 31 and a plurality of terminals, which includes at least one detection terminal 32 and a plurality of power terminals 33. The insulative housing 31, the detection terminal 32 and the power terminals 33 are disposed on and affixed to the circuit board 96. The detection terminal 32 and the power terminals 33 are disposed in the insulative housing 31. The insulative housing 31 includes electrically insulative material. The detection terminal 32 and the power terminals 33 include electrically conductive material such as copper.

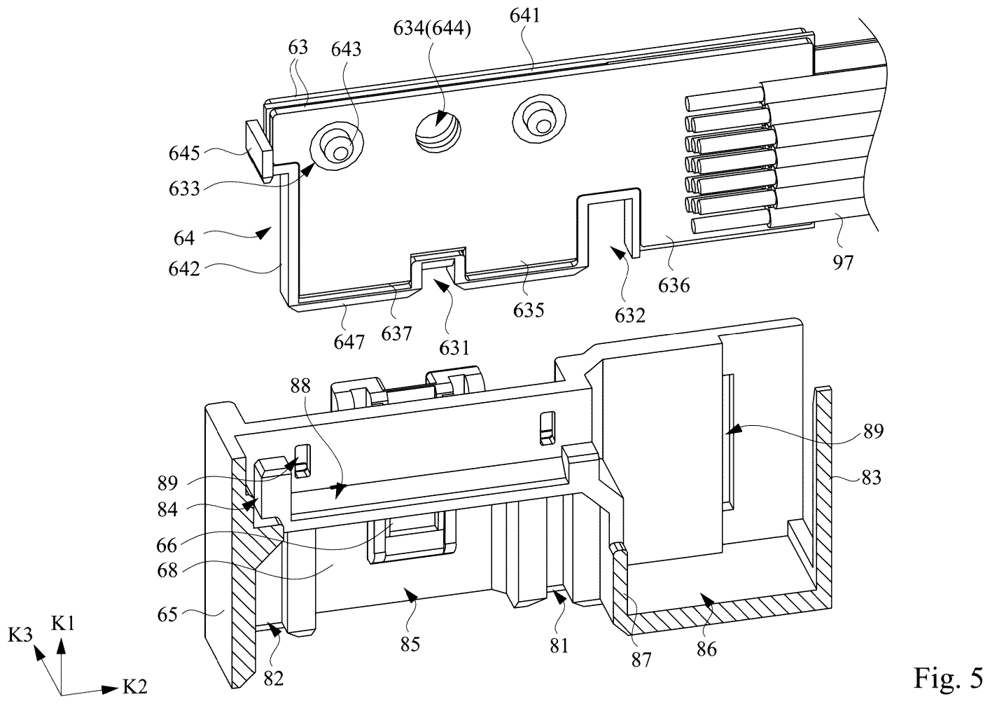

As shown in FIG. 2, the cable-end connector 60 includes an insulative housing 61 and a plurality of cable-end terminals 63 (see FIG. 5). The cable-end terminals 63 are disposed in the insulative housing 61 and include electrically conductive material such as copper. The cable-end terminals 63 are configured to make contact with and be electrically connected to the detection terminal 32 and the power terminals 33 of the board-end connector 30. The cable assembly 97 includes at least one cable. One end of each cable is electrically connected to the cable-end terminals 63 (e.g., one end of each cable is soldered to the cable-end terminals 63), and the cables extend out of the insulative housing 61 from one side of the insulative housing 61. The cable-end connector 60 may further include an inner mold 62. The inner mold 62 is disposed in the insulative housing 61 and wraps around part of the cable-end terminals 63 and part of the cable assembly 97. The inner mold 62 can hold the cable-end terminals 63 and the cable assembly 97 in position inside the insulative housing 61 and can ensure that the cable-end terminals 63 and the cable assembly 97 are securely connected (e.g., the inner mold 62 can protect the solder joints between the cable-end terminals 63 and the cable assembly 97). The inner mold 62 includes electrically insulative material. The inner mold 62 can be formed by injection molding.

As shown in FIG. 2, the insulative housing 61 of the cable-end connector 60 includes a main body 65 and two latches 66. The two latches 66 are disposed on two sides of the main body 65, respectively. In the present embodiment, the two latches 66 are disposed on two long sides of the main body 65. Each of the latches 66 is rotatably disposed on the main body 65 via a pivot structure 663 and is configured to interlock with the insulative housing 31 of the board-end connector 30, so as to ensure the board-end connector 30 and the cable-end connector 60 are securely connected. In some embodiments, the latches 66 may be slidably disposed on the main body 65 along a guiding component (e.g. groove) to be engaged with or disengaged from the insulative housing 31. The insulative housing 61 may have two recesses on the two long sides corresponding to the two latches 66 and matching the shape of the two latches 66 in part or in entirety, such that the two latches 66 are partially or entirely accommodated in the two recesses. Each of the two latches 66 further includes an operation portion 661 and a latching portion 662. The operation portion 661 and the latching portion 662 are located on two sides of the pivot structure 663, respectively. An outer surface of the latching portion 662 is flush with or lower than an outer surface of the insulative housing 61. The latching portion 662 is configured to interlock with the insulative housing 31 of the board-end connector 30. The operation portion 661 can be pressed by a user. When the operation portion 661 is pressed, the latching portion 662 disengages from the insulative housing 31 of the board-end connector 30, enabling the cable-end connector 60 to be separated from the board-end connector 30. An outer surface of the operation portion 661 is flush with or higher than the outer surface of the insulative housing 61. Hence, providing recesses at positions corresponding to the two latches 66 can reduce the distances by which the latches 66 project from the insulative housing 61 and thus reduce the size of the cable-end connector 60.

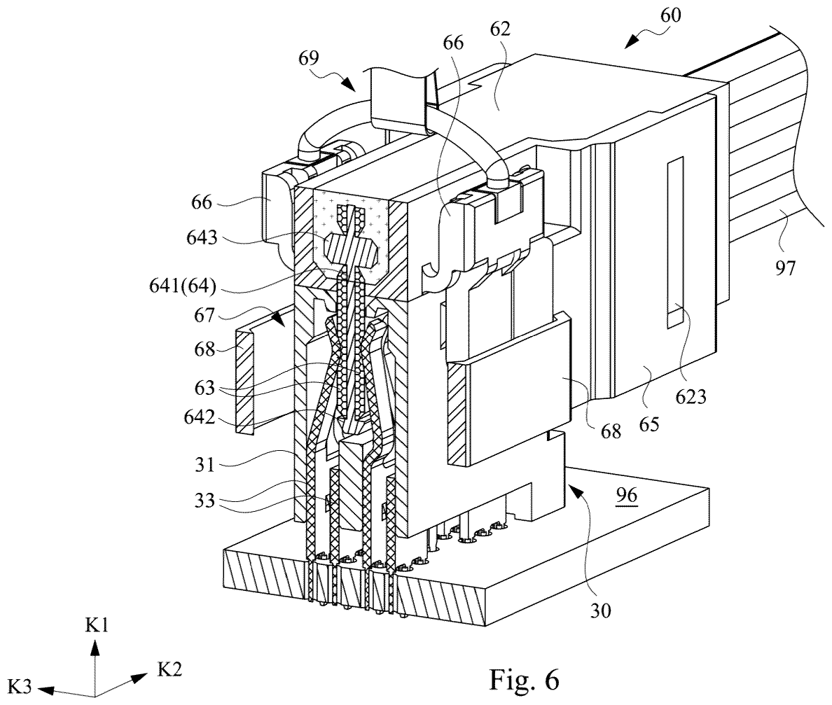

As shown in FIG. 2, in some embodiments, the main body 65 of the insulative housing 61 of the cable-end connector 60 has two side openings 67 (also see FIG. 6) provided on two opposite sides of the cable-end terminals 63. The two latches 66 are positioned to face the two side openings 67, respectively. In some embodiments, the main body 65 further includes two guarding walls 68. Each guarding wall 68 partially covers a corresponding side opening 67 and a corresponding latch 66. The guarding walls 68 can protect the latches 66 and improve the dust-proof capability of the cable-end connector 60. The two guarding walls 68 slightly project outward. A maximum distance between outer sides of the two guarding walls 68 (e.g., equivalent to a maximum width of the cable-end connector 60 in a third direction K3) is greater than or equal to 10 mm, preferably greater than or equal to 15 mm.

As shown in FIG. 2, in some embodiments, the cable-end connector 60 further includes an unlocking device 69 connected to the two latches 66. The unlocking device 69 includes a pull tape 691 and an interconnection component 692. The interconnection component 692 extends across the main body 65, and two ends of the interconnection component 692 are connected to the operation portions 661 of the two latches 66, respectively. The pull tape 691 is connected to a middle section of the interconnection component 692. The pull tape 691 can be pulled by a user. Pulling the pull tape 691 can achieve the same purpose as pressing the operation portion 661 of the latches 66, i.e., enabling the cable-end connector 60 to be separated from the board-end connector 30. In some embodiments, the interconnection component 692 may have a curved shape. In some embodiments, the interconnection component 692 may be a flexible plastic part.

As shown in FIG. 2, the insulative housing 31 of the board-end connector 30 includes a base portion 35 and a mating portion 36. The base portion 35 is located on a side of the board-end connector 30 adjacent to the circuit board 96. The mating portion 36 is located on a side of the board-end connector 30 away from the circuit board 96. When the board-end connector 30 mates with the cable-end connector 60, the mating portion 36 is inserted into the cable-end connector 60.

As shown in FIG. 2, in some embodiments, the base portion 35 of the insulative housing 31 includes two wings 37. The two wings 37 are disposed on two opposite sides of the base portion 35 and are each fixedly attached to the circuit board 96 via a fixing part 38. The two wings 37 are projecting structures on the base portion 35. The base portion 35 is located between the two wings 37. In a second direction K2, the two wings 37 are projecting structures compared to the mating portion 36. The fixing part 38 is, for example, a metal piece. Each fixing part 38 can hook onto a respective wing 37. In some embodiments, the base portion 35 of the insulative housing 31 has an opening 34. The opening 34 is adjacent to the circuit board 96 and exposes part of the detection terminal 32 and the power terminals 33 (also see FIG. 1) to facilitate heat dissipation of the detection terminal 32 and the power terminals 33.

As shown in FIG. 2, the mating portion 36 of the insulative housing 31 has a slot 39. The slot 39 and the opening 34 are located on two opposite sides of the insulative housing 31. The slot 39 is configured to receive the cable-end terminals 63 of the cable-end connector 60. The detection terminal 32 and the power terminals 33 are partially exposed in the slot 39 to make contact with the cable-end terminals 63 of the cable-end connector 60. When the detection terminal 32 contacts the cable-end terminals 63, a detection signal is generated and is indicative of a connection state or a power state between the board-end connector 30 and the cable-end connector 60. The detection terminal 32 and at least one of the power terminals 33 may be configured to make contact with the same cable-end terminal 63. Hence, the generated signal can correctly reflect the actual connection state or power state. The slot 39 forms a top opening on a top surface of the insulative housing 31 (or the mating portion 36) and forms two side openings on two lateral surfaces of the insulative housing 31 (or the mating portion 36). The two side openings communicate with the top opening. The two side openings have different depths (e.g., have different lengths in the mating direction K1). The corners at which the top surface and the lateral surfaces of the insulative housing 31 meet are provided with chamfers. In other embodiments, the board-end connector 30 can mate with an edge card. The slot 39 can receive the edge card. The detection terminal 32 and the power terminals 33 are configured to make contact with electrical contact pads of the edge card.

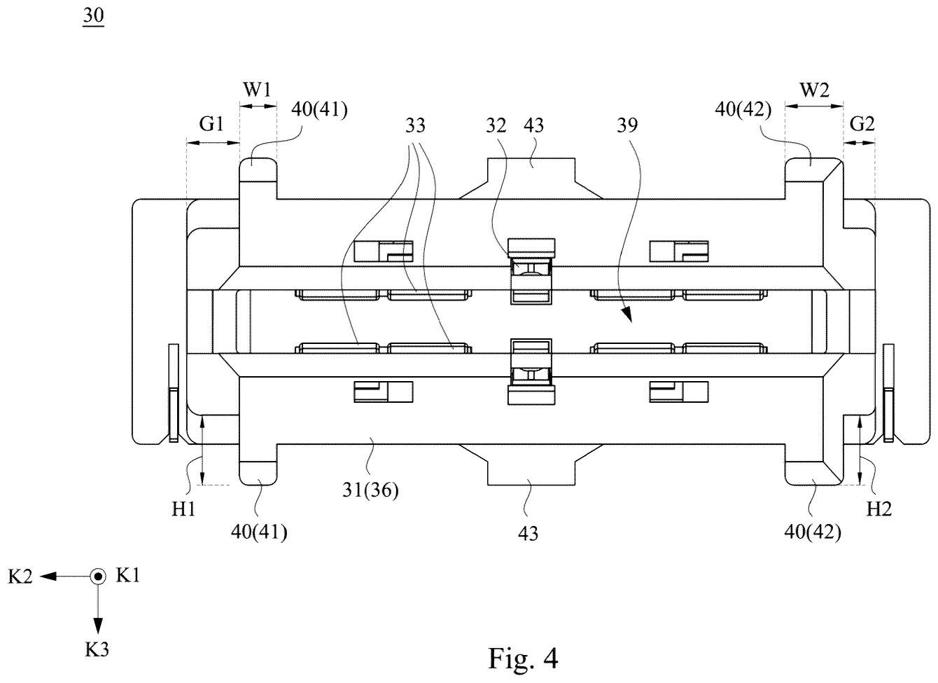

As shown in FIG. 2, in some embodiments, the mating portion 36 of the insulative housing 31 includes at least one hook 43. The latching portion 662 of at least one of the two latches 66 of the cable-end connector 60 is configured to interlock with the hook 43. In the present embodiment, the mating portion 36 of the insulative housing 31 includes two hooks 43 (also see FIG. 4). The two hooks 43 are provided on two opposite sides of the mating portion 36 and each interlock with one of the two latches 66 of the cable-end connector 60.

As shown in FIG. 2, in some embodiments, the mating portion 36 of the insulative housing 31 further includes at least one guiding strip 40. The guiding strip 40 is disposed on at least one lateral surface of the mating portion 36 and extends along the mating direction K1 of the board-end connector 30 and the cable-end connector 60. In some embodiments, the mating portion 36 of the insulative housing 31 includes at least one first guiding strip 41 and at least one second guiding strip 42. The first guiding strip 41 and the second guiding strip 42 have different physical dimensions and/or symmetric positions.

As shown in FIG. 2, the detection terminal 32 and the power terminals 33 of the board-end connector 30 are mounted upright on the circuit board 96 and are divided into two groups. The two groups of terminals are disposed on two opposite sides of the slot 39 of the insulative housing 31, respectively, and thereby forming two rows of terminals. Each group of terminals may include at least one power terminal set, and each power terminal set includes multiple power terminals 33. Hence, the board-end connector 30 includes at least two power terminal sets disposed on two opposite sides of the slot 39 of the insulative housing 31. For each power terminal set, contact portions 332 (or elastic arms) of the multiple power terminals 33 are arranged linearly in the second direction K2. In the present embodiment, each group of terminals includes one detection terminal 32 and four power terminals 33. Two power terminals form a power terminal set. The detection terminal 32 and two sets of power terminal 33 are arranged along the second direction K2 (which is normal to the mating direction K1), and the detection terminal 32 is located between the two sets of power terminals 33. The two sets of power terminals 33 may transmit the same or different voltages. In some embodiments, only one of the two groups of terminals includes the detection terminal 32. In other words, the detection terminal 32 is disposed on only one side of the slot 39, and the detection terminal 32 is at a position corresponding to one of the cable-end terminals 63 of the cable-end connector 60 that transmits a positive voltage.

As shown in FIG. 2, each of the power terminals 33 includes a leg portion 331, a contact portion 332, and a middle portion 333 connected between the leg portion 331 and the contact portion 332. In the second direction K2, the middle portion 333 has a greater width than both the leg portion 331 and the contact portion 332. The leg portion 331 extends out of the insulative housing 31 and is electrically connected to the circuit board 96. The leg portion 331 includes a plurality of tails that are inserted into and joined with the circuit board 96. For each power terminal 33, the multiple tails are arranged into a row in the second direction K2. The contact portion 332 is exposed in the slot 39 and includes at least one elastic arm. The middle portion 333 may include a retention structure 334 through which the power terminal 33 can be affixed to the insulative housing 31. The retention structure 334 may include one or more bumps projecting from lateral surfaces and/or lateral edges of the middle portion 333.

As shown in FIG. 2, in the present embodiment, the leg portion 331 includes three tails, and the contact portion 332 includes a single elastic arm. In other embodiments, the contact portion 332 may include multiple elastic arms arranged along the second direction K2.

As shown in FIG. 2, in the present embodiment, each set of power terminals 33 includes two power terminals 33P and 33Q. The leg portions 331 of the power terminals 33P and 33Q are spaced apart from each other in the third direction K3. The middle portions 333 of the power terminals 33P and 33Q are also spaced apart from each other in the third direction K3. The third direction K3 is substantially normal to the mating direction K1 and the second direction K2, and the second direction K2 is substantially normal to the mating direction K1. Hence, an arrangement direction of the contact portions 332 of the power terminals 33 in the same power terminal set is normal to an arrangement direction of the middle portions 333 of the power terminals 33 in the same power terminal set. The power terminal 33P further includes a bending portion 335 connected between the contact portion 332 and the middle portion 333. Thereby, a contact region 336 of the contact portion 332 of the power terminal 33P and a contact region 336 of the contact portion 332 of the power terminal 33Q are substantially coplanar. The contact region 336 is located on the elastic arm and is configured to make contact with the cable-end terminals 63 of the cable-end connector 60. In the mating direction K1, the contact regions 336 of the power terminals 33P and 33Q are at different heights. This can help reduce the force required to plug the cable-end connector 60 into the board-end connector 30. In other words, the contact regions 336 of the power terminals 33P and 33Q are at different distances to an entrance of the slot 39. Moreover, the tails of the leg portions 331 of the power terminals 33P and 33Q in the same power terminal set are arranged into multiple rows on the circuit board 96 to allow the board-end connector 30 to carry larger electric current. Two adjacent rows of tails can be in an aligned configuration in the third direction K3 as shown in the drawings, and can also be in a staggered configuration.

As shown in FIG. 2, each detection terminal 32 may also include a leg portion 321 and a contact portion 322, and the contact portion 322 may include at least one elastic arm. In some embodiments, the mating portion 36 of the insulative housing 31 has a retaining aperture 44. One end of the contact portion 322 of the detection terminal 32 is disposed in the retaining aperture 44.

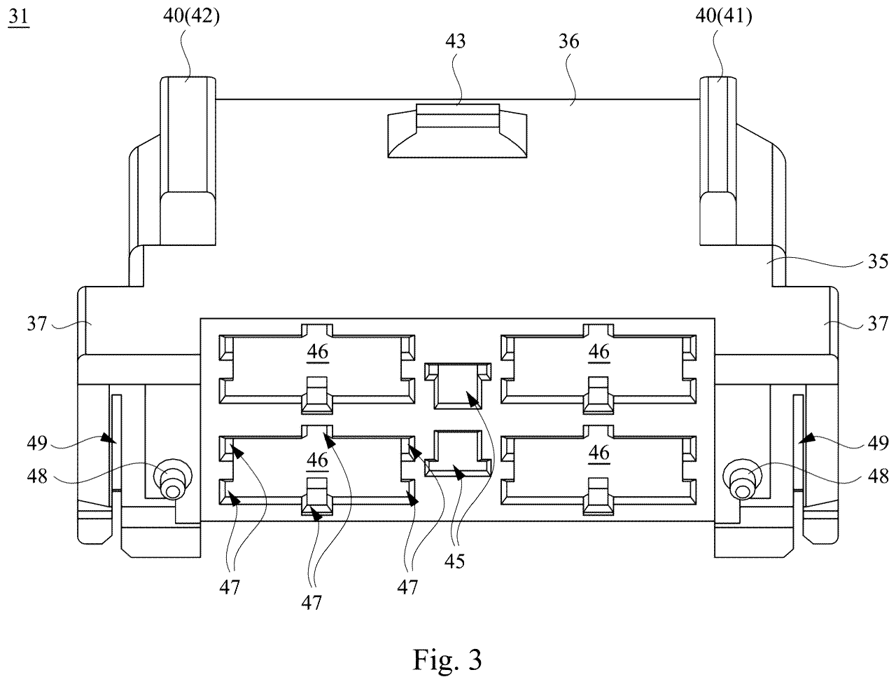

Reference is made to FIG. 3, which illustrates an axonometric view of the insulative housing 31 of the board-end connector 30 shown in FIG. 2. As shown, the insulative housing 31 further has a plurality of detection terminal channels 45 and a plurality of power terminal channels 46. Each detection terminal 32 is disposed in one of the detection terminal channels 45. Each set of power terminals 33 is disposed in one of the power terminal channels 46. The insulative housing 31 further has at least one blocking groove 47 disposed on at least one edge of the power terminal channel 46. The retention structure 334 of the power terminal 33 mentioned above engages the blocking groove 47.

As shown in FIG. 3, in some embodiments, the base portion 35 of the insulative housing 31 further includes at least one positioning post 48. The positioning post 48 projects from a lower side of the insulative housing 31 and serves to position the insulative housing 31 on the circuit board 96. In some embodiments, the two wings 37 each as a fixing hole 49 for receiving the fixing part 38 mentioned above.

Reference is made to FIG. 4, which illustrates a top view of the board-end connector 30 shown in FIG. 1. As shown, the guiding strips 40 of the insulative housing 31 can act as a foolproof structure to ensure that the cable-end connector 60 is plugged into the board-end connector 30 in the correct orientation. In some embodiments, in the second direction K2, a width W1 of the first guiding strip 41 is different from a width W2 of the second guiding strip 42. In some embodiments, in the second direction K2, a distance G1 from a lateral surface of the first guiding strip 41 to an adjacent lateral surface of the mating portion 36 is different from a distance G2 from a lateral surface of the second guiding strip 42 to an adjacent lateral surface of the mating portion 36. In some embodiments, in the third direction K3, the first guiding strip 41 projects from the mating portion 36 by a first distance H1, and the second guiding strip 42 projects from the mating portion 36 by a second distance H2 different from the first distance H1.

Reference is made to FIGS. 5 and 6. FIG. 5 illustrates an exploded view of some components of the cable-end connector 60 shown in FIG. 1. FIG. 6 illustrates a sectional view of the power connector assembly 29 shown in FIG. 1. As shown, in the present embodiment, the cable-end connector 60 includes a mating member, which includes two cable-end terminals 63. The two cable-end terminals 63 are provided on two faces of the mating member, respectively, and are electrically isolated from each other. The mating member is configured to be inserted into the slot 39 of the board-end connector 30 and make contact with the detection terminal 32 and the power terminals 33 of the board-end connector 30. The cable assembly 97 is electrically connected to the cable-end terminals 63 of the mating member.

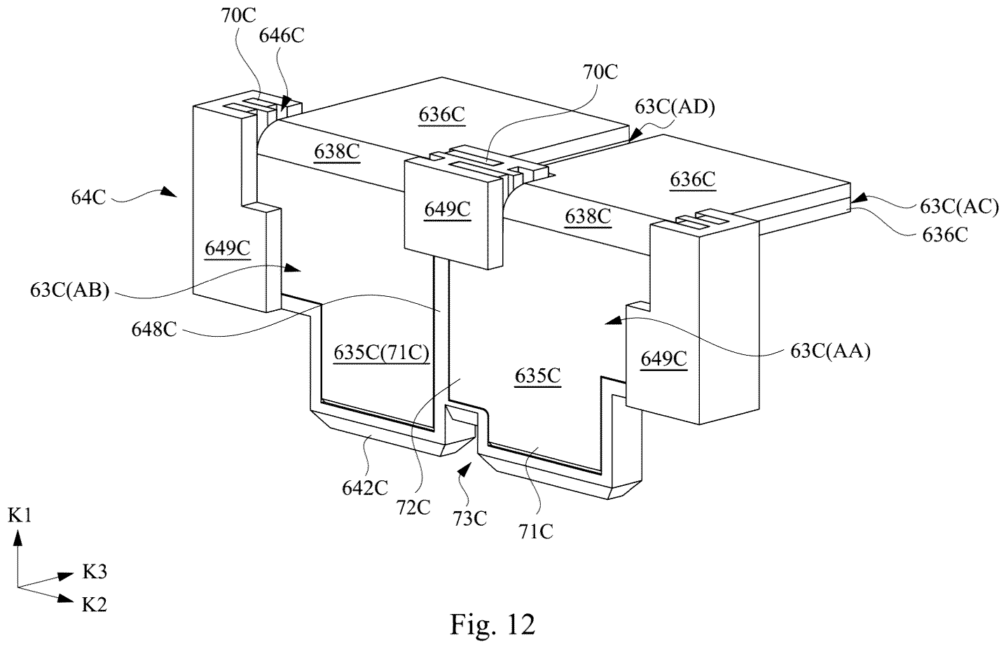

As shown in FIGS. 5 and 6, the mating member may further include a terminal spacer 64 formed of electrically insulative material. The terminal spacer 64 is disposed between the two cable-end terminals 63 and isolates the two cable-end terminals 63. The two cable-end terminals 63 and the terminal spacer 64 are stacked in the third direction K3, and the two cable-end terminals 63 are disposed on two opposite sides of the terminal spacer 64, respectively. The terminal spacer 64 has a region that is stacked with the two cable-end terminals 63, and said region has a thickness of at least 0.1 mm, preferably greater than or equal to 0.15 mm. The two cable-end terminals 63 are configured to make contact with the two rows (or groups) of terminals of the board-end connector 30. The two cable-end terminals 63 can be clamped by the two rows (or groups) of terminals of the board-end connector 30. The two cable-end terminals 63 may transmit different voltages. The two cable-end terminals 63 can be planar, or can be partially bent as needed (e.g., see FIG. 12).

As shown in FIGS. 5 and 6, each cable-end terminal 63 includes a contact portion 635 and a cable connection portion 636. The contact portion 635 and the cable connection portion 636 are connected to each other and are linearly arranged in the second direction K2. The contact portion 635 is configured to make contact with the detection terminal 32 and the power terminals 33 of the board-end connector 30. The contact portions 635 of the two cable-end terminals 63 are substantially planar and are provided on two faces of the mating member, respectively. In the present embodiment, the contact portion 635 is rigid, and the detection terminal 32 and the power terminals 33 can maintain their contact with contact portion 635 by virtue of the spring force of their elastic arms. The cable connection portion 636 is connected to the cable assembly 97. In the present embodiment, the cable connection portion 636 is a plate structure extending straight along the second direction K2. The cable assembly 97 extends out of the insulative housing 61 along the second direction K2.

As shown in FIGS. 5 and 6, in some embodiments, in the third direction K3, the contact portion 635 of the cable-end terminal 63 has a thickness of at least 0.4 mm to facilitate transmission of large electric current. In some embodiments, the contact portion 635 of the cable-end terminal 63 has a thickness of at least 0.5 mm in the third direction K3. In some embodiments, a lower edge of the mating member has at least one chamfer. For example, a lower edge (or front edge) of the contact portion 635 of the cable-end terminal 63 can have at least one chamfer 637. For example, a lower edge (or front edge) of the terminal spacer 64 can have at least one chamfer 647. By this arrangement, the cable-end terminals 63 can be inserted into the slot 39 of the board-end connector 30 more smoothly.

As shown in FIGS. 5 and 6, in some embodiments, the terminal spacer 64 includes a plate portion 641 and a projecting rim 642. The plate portion 641 is disposed between the two cable-end terminals 63. The projecting rim 642 is disposed along a periphery of the plate portion 641, and the projecting rim 642 has a greater thickness than the plate portion 641. When the terminal spacer 64 is combined with the two cable-end terminals 63, the projecting rim 642 of the terminal spacer 64 covers lower edges of the contact portions 635 of the cable-end terminals 63. In some embodiments, the projecting rim 642 has at least one chamfer 647.

As shown in FIGS. 5 and 6, in some embodiments, the terminal spacer 64 further includes at least one fixing post 643 disposed on at least one lateral surface of the plate portion 641. Correspondingly, at least one of the cable-end terminals 63 has at least one through hole 633. The fixing post 643 extends through the through hole 633. In some embodiments, the fixing post 643 can be hot-melt such that at least one of the cable-end terminals 63 is held fixed to the terminal spacer 64. In some embodiments, each side of the terminal spacer 64 is provided with at least one fixing post 643. The fixing posts 643 on two sides of the terminal spacer 64 can be used to fix the two cable-end terminals 63, respectively. In some embodiments, each of the cable-end terminals 63 further has a through hole 634, and the terminal spacer 64 has a corresponding through hole 644. The through holes 634 and 644 are aligned with one another. The inner mold 62 of the cable-end connector 60 can fill into the through holes 634 and 644 to fixedly combine the cable-end terminals 63 and the terminal spacer 64.

As shown in FIGS. 5 and 6, in some embodiments, the lower edge of the contact portion 635 of the cable-end terminal 63 has a first notch 631. The first notch 631 is at a position corresponding to the detection terminal 32 of the board-end connector 30. In some embodiments, the terminal spacer 64 has another notch corresponding to the first notch 631.

As shown in FIGS. 5 and 6, in some embodiments, the terminal spacer 64 further includes a plank 645. The plank 645 is disposed on a side of the terminal spacer 64 away from the cable assembly 97 (or away from the cable connection portion 636 of the cable-end terminals 63). Correspondingly, the main body 65 of the insulative housing 61 of the board-end connector 60 has a positioning trough 84. The positioning trough 84 is configured to receive the plank 645 of the terminal spacer 64 to facilitate positioning the cable-end terminals 63 and the terminal spacer 64 in the insulative housing 61. In some embodiments, the main body 65 of the insulative housing 61 further includes a positioning pillar 83. Each of the cable-end terminals 63 has an edge away from the plank 645 and abutting the positioning pillar 83, such that the cable-end terminals 63 are held between the plank 645 and the positioning pillar 83.

As shown in FIGS. 5 and 6, in some embodiments, the main body 65 of the insulative housing 61 of the cable-end connector 60 has a mating chamber 85 and a cable chamber 86. The mating chamber 85 is configured to receive the board-end connector 30. Specifically, the mating portion 36 of the insulative housing 31 of the board-end connector 30 is configured to be inserted into the mating chamber 85. The cable chamber 86 can accommodate a section of the cable assembly 97. The two side openings 67 of the main body 65 are located on two sides of the mating chamber 85, respectively, communicate with the mating chamber 85, and jointly accommodate the mating portion 36 of the insulative housing 31. The contact portions 635 of the cable-end terminals 63 are located in mating chamber 85, and the lower edges of the contact portions 635 face an entrance of the mating chamber 85. The cable connection portions 636 of the cable-end terminals 63 are located in the cable chamber 86. The mating chamber 85 and the cable chamber 86 are separated by a partitioning wall 87. Correspondingly, the cable-end terminals 63 each have a second notch 632 for receiving the partitioning wall 87. In other words, the partitioning wall 87 is inserted into the second notch 632 to position the mating member (including the cable-end terminals 63 and the terminal spacer 64) in the insulative housing 61. The terminal spacer 64 may have a notch for receiving the partitioning wall 87 as well. A portion of the mating member that is located in the mating chamber 85 (not including the chamfer 647) has a thickness of at least 0.4 mm, preferably greater than or equal to 0.5 mm. The cable chamber 86 has a cable port on a side away from the mating chamber 85. The cable assembly 97 extends out of the insulative housing 61 via the cable port. The positioning pillar 83 is in the middle of the cable port, and the positioning pillar extends in the mating direction K1 to divide the cable port into a first area and a second area. A first subset of the cables of the cable assembly 97 that are connected to one of the cable-end terminals 63 on one side of the mating member passes through the first area. A second subset of the cables of the cable assembly 97 that are connected to the other one of the cable-end terminals 63 on the other side of the mating member passes through the second area.

As shown in FIGS. 5 and 6, in some embodiments, the main body 65 of the insulative housing 61 further has at least one first guiding groove 81 and at least one second guiding groove 82. The first guiding groove 81 and the second guiding groove 82 are provided on lateral sides the mating chamber 85 and are located on two sides of the side opening 67. The first guiding groove 81 and the second guiding groove 82 are configured to receive the first guiding strip 41 and the second guiding strip 42 of the insulative housing 31 mentioned above. Positions and physical dimensions of the first guiding groove 81 and the second guiding groove 82 match those of the first guiding strip 41 and the second guiding strip 42, respectively. In some embodiments, in the second direction K2, the first guiding groove 81 and the second guiding groove 82 have different widths. In some embodiments, in the second direction K2, a distance from a lateral surface of the first guiding groove 81 to an adjacent lateral surface of the mating chamber 85 is different from a distance from a lateral surface of the second guiding groove 82 to an adjacent lateral surface of the mating chamber 85. In some embodiments, in the third direction K3, the first guiding groove 81 and the second guiding groove 82 have different depths.

As shown in FIGS. 5 and 6, in some embodiments, the main body 65 of the insulative housing 61 further has at least one bevel 88 located on a side of the mating chamber 85 away from its entrance. During the production of the cable-end connector 60, the bevel 88 can guide the installation of the mating member (including the cable-end terminals 63 and the terminal spacer 64) to the correct position in the insulative housing 61.

As shown in FIGS. 5 and 6, in some embodiments, the main body 65 of the insulative housing 61 of the cable-end connector 60 further has at least one hole 89. The inner mold 62 can fill into the hole 89 such that the inner mold 62 can be held fixed in the insulative housing 61. In some embodiments, a method of manufacturing the cable-end connector 60 may include: (1) combining the cable-end terminals 63 and the terminal spacer 64 (e.g., by means of hot-melting); (2) connecting the cable assembly 97 to the cable-end terminals 63 (e.g., soldering the cable assembly 97 to the cable-end terminals 63); (3) assembling the cable-end terminals 63, the terminal spacer 64 and the cable assembly 97 into the insulative housing 61 together; (4) after completing the foregoing steps, forming the inner mold 62 in the insulative housing 61 by means of injection molding. The inner mold 62 wraps around part of the cable-end terminals 63, the terminal spacer 64 and the cable assembly 97, while exposing the contact portions 635 of the cable-end terminals 63. The inner mold 62 can completely fill up the cable chamber 86, but does not fill into the mating chamber 85.

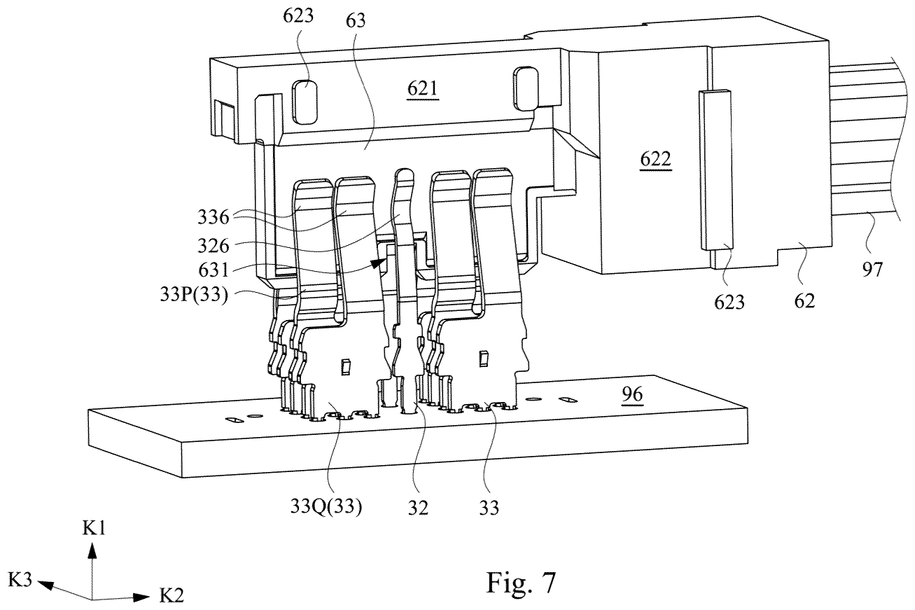

Reference is made to FIG. 7, which illustrates an axonometric view of some components of the power connector assembly 29 shown in FIG. 1. As shown, the inner mold 62 may include a first portion 621 and a second portion 622. The first portion 621 wraps around upper edges of the cable-end terminals 63 and the terminal spacer 64 to fixedly combine the cable-end terminals 63 and the terminal spacer 64. The second portion 622 wraps around one end of the cable assembly 97 and the cable connection portions 636 of the cable-end terminals 63 mentioned above, such that the cable assembly 97 and the cable-end terminals 63 are fixedly combined. The contact portions 635 of the cable-end terminals 63 mentioned above are exposed out of the inner mold 62. The inner mold 62 may be formed with at least one bump 623 on its lateral sides. The at least one bump 623 corresponds to the at least one hole 89 of the insulative housing 61 mentioned above.

In some embodiments, at least one electronic component (not depicted) is disposed on the circuit board 96. The electronic component is electrically connected to the detection terminal 32 and the power terminals 33 of the board-end connector 30. A procedure for powering the electronic component may include: (1) the electronic component receives the detection signal via the detection terminal 32, the detection signal indicates that the power terminals 33 and the cable-end connector 60 are securely connected (i.e., the transmitted voltages are within specification); and (2) in response to receiving the detection signal, the electronic component starts to operate. By this arrangement, damage or abnormal operation of the electronic component can be prevented.

As shown in FIG. 7, when the cable-end terminal 63 has the first notch 631, during the process of connecting the cable-end connector 60 to the board-end connector 30, the moment at which the detection terminal 32 contacts the cable-end terminal 63 is later than the moment at which the power terminals 33 contact the cable-end terminal 63. Consequently, it can be ensured that only after the power terminal 33 and the cable-end terminal 63 become stably connected will the electronic component receive the detection signal via the detection terminal 32.

As shown in FIG. 7, in some embodiments, in the mating direction K1, the contact region 326 of the detection terminal 32 is at a position lower than the contact regions 336 of the power terminals 33P and 33Q. In other words, a distance from the contact region 326 of the detection terminal 32 to the entrance of the slot 39 mentioned above is greater than a distance from the contact region 336 of the power terminal 33P or 33Q to the entrance of the slot 39. By this arrangement, it can be ensured that only after the power terminal 33 and the cable-end terminal 63 become stably connected will the electronic component receive the detection signal via the detection terminal 32.

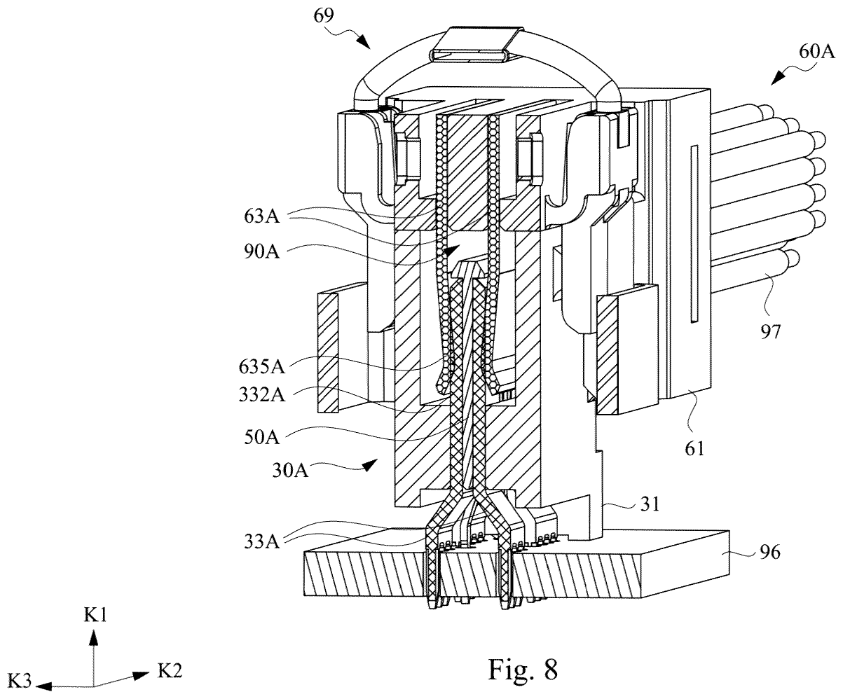

Reference is made to FIG. 8, which illustrates a sectional view of a power connector assembly in accordance with another embodiment of the present disclosure. Differences between the present embodiment and the previous includes: (1) the cable-end terminals 63A of the cable-end connector 60A are spaced apart from each other and form an insertion slot 90A in between; (2) the contact portions 635 of the cable-end terminals 63A of the cable-end connector 60A include elastic arms, the elastic arms are curved inwardly (towards the insertion slot 90A); (3) the contact portions 332A of the power terminals 33A of the board-end connector 30A are rigid and planar, the contact portions 332A of the power terminals 33A are configured to be inserted into the insertion slot 90A and contact the elastic arms of the cable-end terminals 63A (in other words, the contact portions 332A of the power terminals 33A are clamped by the elastic arms of the cable-end terminals 63A), and moreover, the detection terminal (not depicted) of the present embodiment can also be rigid and planar, and can make contact with the elastic arms of the cable-end terminals 63A; (4) a terminal spacer 50A is provided between the contact portions 332A of two sets of terminals of the board-end connector 30A. The terminal spacer 50A may be structurally similar to the terminal spacer 64 described above. The terminal spacer 50A may include a plate portion and a projecting rim. The plate portion is disposed between two sets of power terminals 33A. The projecting rim is disposed along a periphery of the plate portion, and the projecting rim has a greater thickness than the plate portion. The projecting rim covers upper edges (or front edges) of the power terminals 33A and the detection terminal. In addition, the projecting rim can have at least one chamfer.

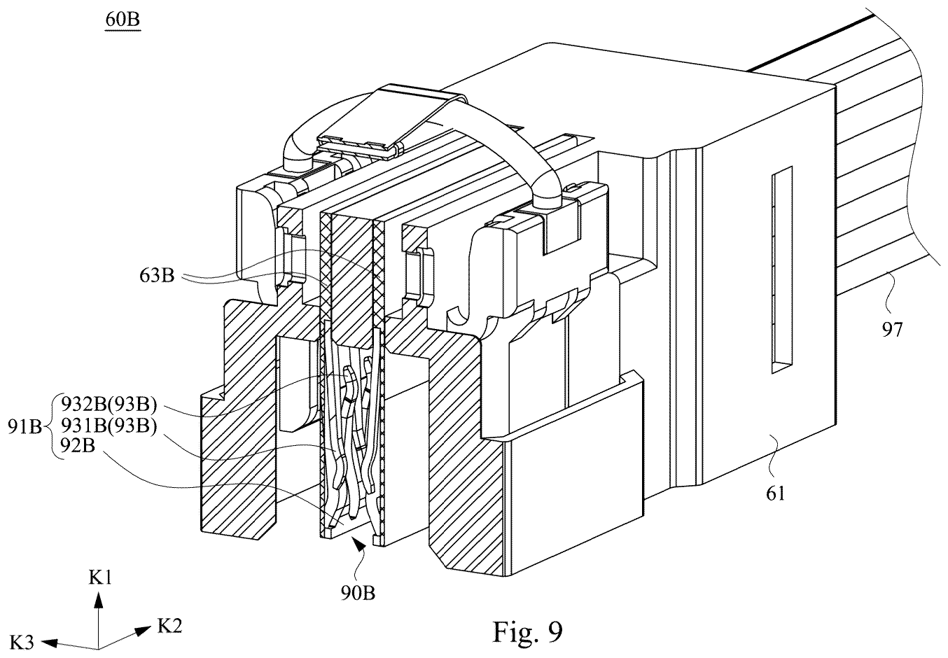

Reference is made to FIG. 9, which illustrates a sectional view of a cable-end connector 60B in accordance with another embodiment of the present disclosure. In the present embodiment, the cable-end terminals 63B of the cable-end connector 60B are also spaced apart from each other and form an insertion slot 90B in between. However, unlike the embodiment shown in FIG. 8, the cable-end terminals 63B of the present embodiment are rigid and planar and do not include any elastic arm. The cable-end connector 60B may further include two contact elements 91B formed of electrically conductive material. Each of the two contact elements 91B is disposed on one of the cable-end terminals 63B and is electrically coupled thereto. The contact elements 91B are positioned on inner sides of the cable-end terminals 63B and face the insertion slot 90B. Each contact elements 91B includes a base portion 92B and at least one elastic arm 93B. The base portion 92B can be affixed to the cable-end terminals 63B by riveting, snap-fitting, laser welding or other suitable means. The elastic arm 93B is connected to the base portion 92B extends at an angle to the base portion 92B. The elastic arm 93B is configured to make contact with the power terminals 33A and the detection terminal of the board-end connector 30A mentioned above.

As shown in FIG. 9, in some embodiments, each of the contact elements 91B can include at least one first elastic arm 931B and at least one second elastic arm 932B. The first elastic arm 931B extends towards an entrance of the insertion slot 90B, whereas the second elastic arm 932B extends away from the entrance of the insertion slot 90B. In some embodiments, the first elastic arm 931B and the second elastic arm 932B are arranged in an interleaved manner.

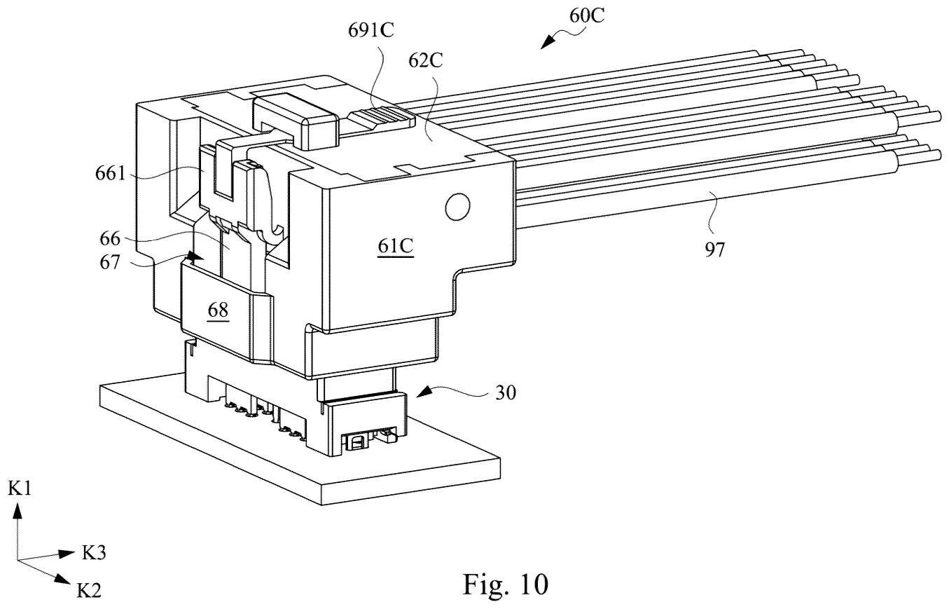

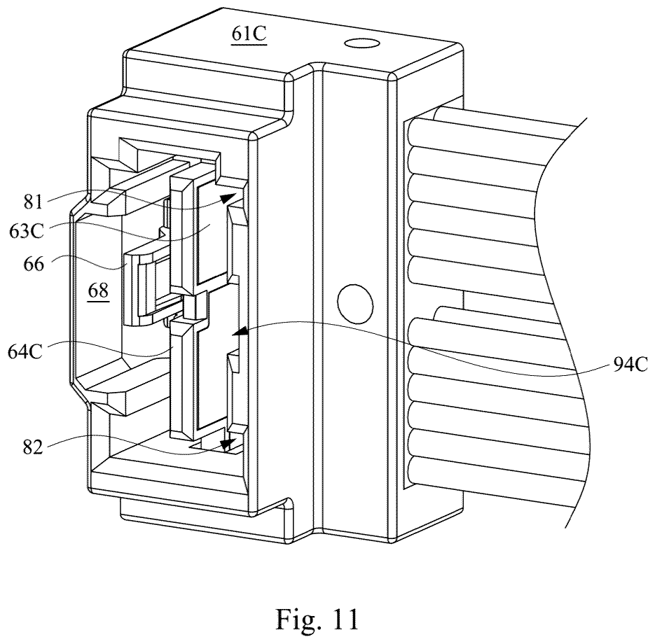

Reference is made to FIGS. 10 and 11. FIG. 10 illustrates an axonometric view of a power connector assembly in accordance with another embodiment of the present disclosure. FIG. 11 illustrates an axonometric view of the cable-end connector 60C shown in FIG. 10. The cable-end connector 60C of the present embodiment is featured with the cable assembly 97 extending from a lateral side of the insulative housing 61C and can mate with the board-end connector 30. One side of the insulative housing 61C has the latch 66, the side opening 67 and the guarding wall 68 as before, while the other side of the insulative housing 61C is entirely covered by a wall and includes a third guiding groove 94C. The third guiding groove 94C is located between the first guiding groove 81 and the second guiding groove 82. The latch 66 is configured to interlock with one of the hooks 43 of the insulative housing 31 of the board-end connector 30 (see FIGS. 2-4). The third guiding groove 94C is configured to receive the other hook 43. Furthermore, the cable-end connector 60C includes a pull tape 691C connected to the operation portion 661 of the latch 66.

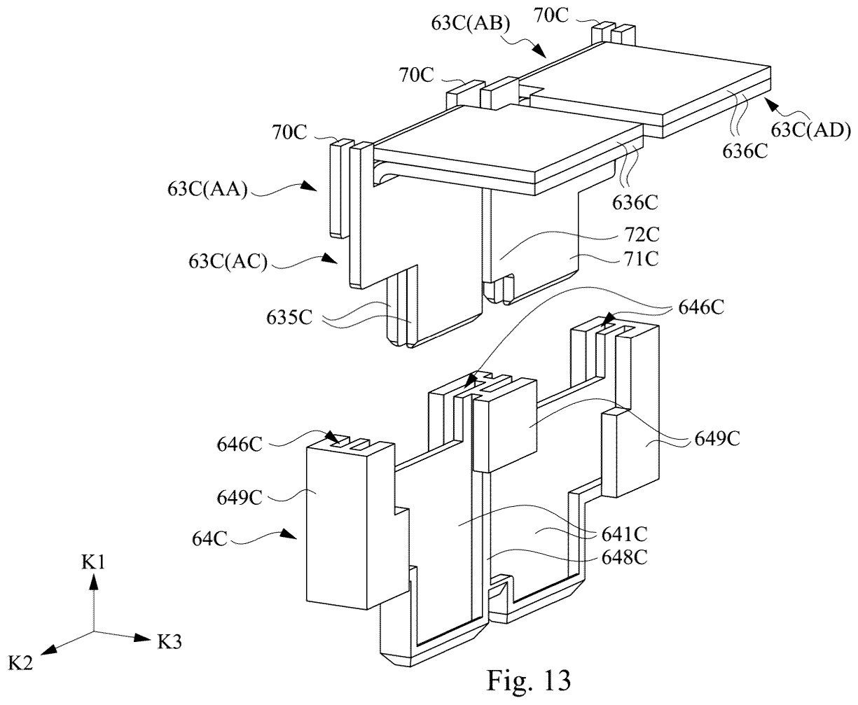

Reference is made to FIGS. 12 and 13. FIGS. 12 and 13 each illustrate an axonometric view of some components of the cable-end connector 60C shown in FIG. 11. As shown, the cable-end connector 60C includes four cable-end terminals 63C: a first cable-end terminal AA, a second cable-end terminal AB, a third cable-end terminal AC and a fourth cable-end terminal AD, all of which are plate-shaped. The first cable-end terminal AA and the second cable-end terminal AB are disposed on one side of the terminal spacer 64C, and the third cable-end terminal AC and the fourth cable-end terminal AD are disposed on another side of the terminal spacer 64C. The first cable-end terminal AA and the third cable-end terminal AC are generally aligned with each other. The second cable-end terminal AB and the fourth cable-end terminal AD are generally aligned with each other. Each cable-end terminal 63C includes a contact portion 635C, a cable connection portion 636C and a middle portion 638C. The contact portion 635C extends along the mating direction K1. The cable connection portion 636C extends along a direction different from the extending direction of the contact portion 635C. For example, the cable connection portion 636C can extend along the third direction K3. The middle portion 638C is connected between an upper edge of the contact portion 635C and the cable connection portion 636C, and the middle portion 638C is bent into an arc. The cable connection portion 636C and the middle portion 638C can be enclosed by the inner mold 62C of the cable-end connector 60C (see FIG. 10). The contact portion 635C is exposed out of the inner mold 62C. In some embodiments, the cable connection portion 636C is wider than the contact portion 635C in the second direction K2. For a pair of cable-end terminals 63C on the same side (e.g., the first cable-end terminal AA and the second cable-end terminal AB, or the third cable-end terminal AC and the fourth cable-end terminal AD), one of them can have a wider the contact portion 635C to make contact with a set of power terminals and a detection terminal of the board-end connector 30, and the other one can have a narrower the contact portion 635C to make contact only with a set of power terminals of the board-end connector 30.

As shown in FIGS. 12 and 13, the terminal spacer 64C includes a plate portion 641C and two partitioning walls 648C located near the center of the plate portion 641C. The plate portion 641C is disposed between the first cable-end terminal AA and the third cable-end terminal AC, and between the second cable-end terminal AB and the fourth cable-end terminal AD. The two partitioning walls 648C project from two sides of the plate portion 641C, respectively. One of the two partitioning walls 648C is disposed between the first cable-end terminal AA and the second cable-end terminal AB, and the other partitioning wall 648C is disposed between the third cable-end terminal AC and the fourth cable-end terminal AD. The plate portion 641C and the two partitioning walls 648C can separate the four cable-end terminals 63C.

In some embodiments, the four cable-end terminals 63C do not make contact with one another and can transmit four different voltages. In some embodiments, the cable connection portions 636C of the first cable-end terminal AA and the third cable-end terminal AC contact each other, and the first cable-end terminal AA and the third cable-end terminal AC can transmit the same voltage. In some embodiments, the cable connection portions 636C of the second cable-end terminal AB and the fourth cable-end terminal AD contact each other, and the second cable-end terminal AB and the fourth cable-end terminal AD can transmit the same voltage.

As shown in FIGS. 12 and 13, the terminal spacer 64C may further include one or more holding portions 649C. The holding portions 649C can be disposed on two sides of the plate portion 641C and/or near the center of the plate portion 641C. The holding portions 649C each include one or more grooves 646C. Correspondingly, each of the cable-end terminals 63C can include at least one extension arm 70C. Each extension arm 70C is inserted into one of the grooves 646C to secure the cable-end terminals 63C to the terminal spacer 64C. Moreover, the terminal spacer 64C may further include a projecting rim 642C disposed along a periphery of the plate portion 641C and covering lower edges of the contact portions 635C of the cable-end terminals 63C.

As shown in FIGS. 12 and 13, the contact portion 635C of each cable-end terminal 63C includes a power contact portion 71C configured to make contact with the power terminals 33 of the board-end connector 30 mentioned above. The contact portions 635C of the first cable-end terminal AA and the fourth cable-end terminal AD further include a signal contact portion 72C, such that the contact portions 635C of the first cable-end terminal AA and the fourth cable-end terminal AD are wider than the contact portions 635C of the second cable-end terminal AB and the third cable-end terminal AC. The signal contact portion 72C is configured to make contact with the detection terminal 32 of the board-end connector 30 mentioned above. The terminal spacer 64C may have a notch 73C. The notch 73C is at a position corresponding to the signal contact portion 72C.

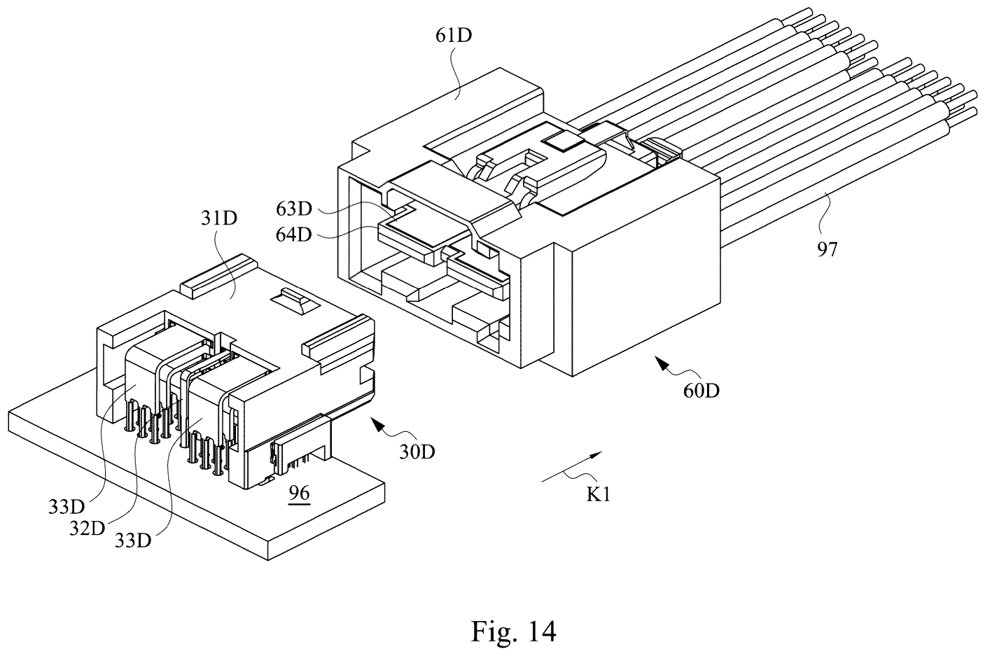

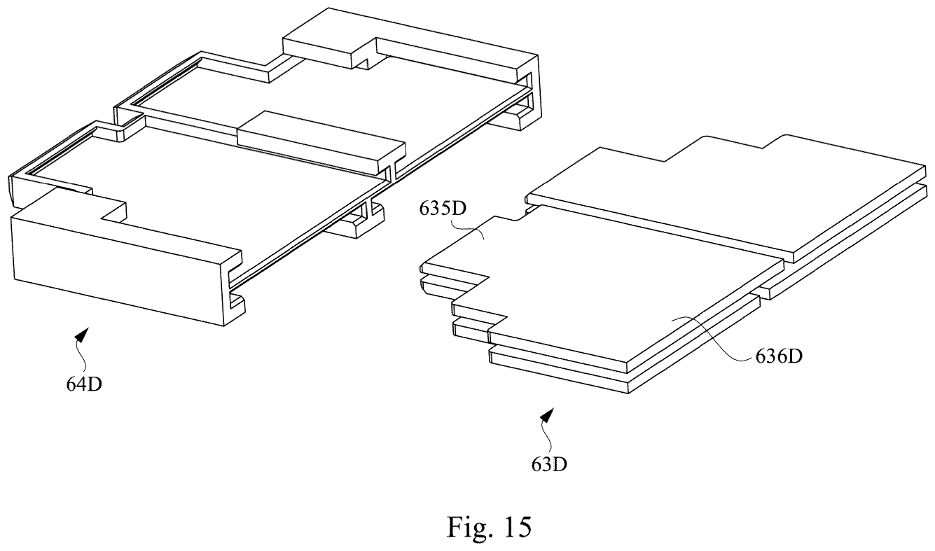

Reference is made to FIGS. 14 and 15. FIG. 14 illustrates an axonometric view of a power connector assembly in accordance with another embodiment of the present disclosure. FIG. 15 illustrates an exploded view of some components of the cable-end connector 60D shown in FIG. 14. Unlike the embodiment shown in FIGS. 12 and 13, the cable-end terminals 63D of the cable-end connector 60D of the present embodiment are planar. The cable connection portion 636D is generally parallel to the contact portion 635D, and the cable connection portion 636D and the contact portion 635D are linearly arranged along the mating direction K1. The cable assembly 97, which is connected to the cable connection portions 636D of the cable-end terminals 63D, also extends along the mating direction K1 and extends out of the insulative housing 61D from a side of insulative housing 61D away from the cable-end terminals 63D. In addition, the terminal spacer 64D of the cable-end connector 60D can be structurally similar to the terminal spacer 64C described above. For example, the terminal spacer 64D can include structures such as the plate portion, the projecting rim, the partitioning wall, the holding portion and the notch.

As shown in FIGS. 14 and 15, the board-end connector 30D mating with the cable-end connector 60D is a right-angle type connector. The insulative housing 31D of the board-end connector 30D lies horizontally on the circuit board 96. The mating direction K1 of the board-end connector 30D is substantially parallel to the surface of the circuit board 96.

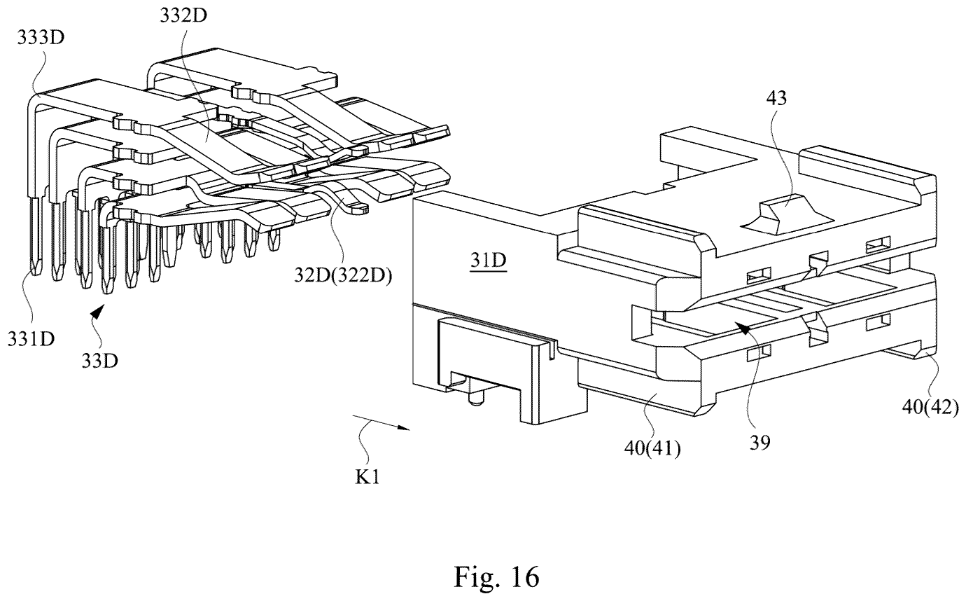

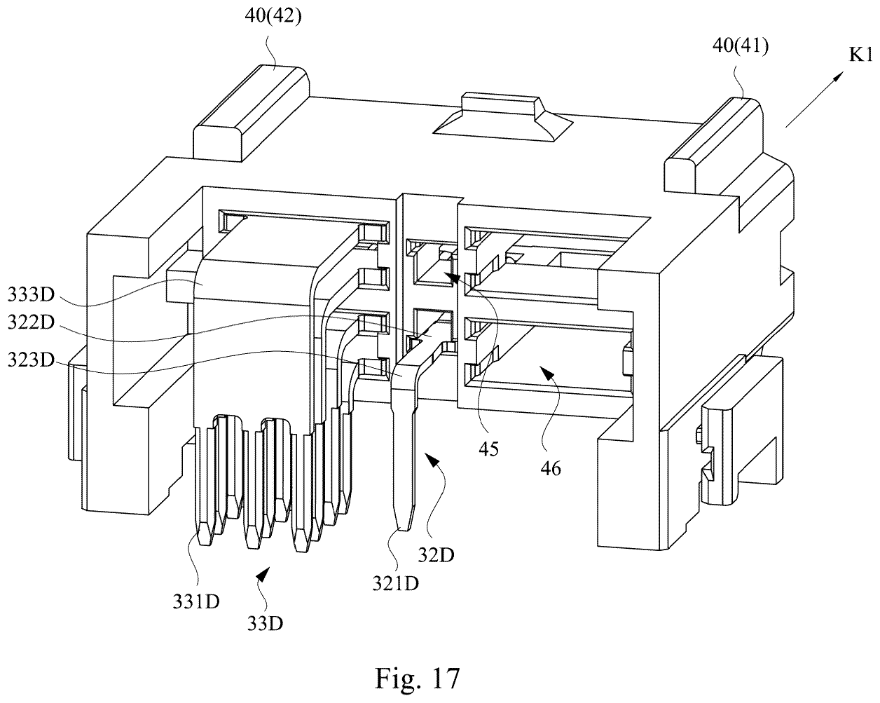

Reference is made to FIGS. 16 and 17. FIG. 16 illustrates an exploded view of the board-end connector 30D shown in FIG. 14. FIG. 17 illustrates an axonometric view of some components of the board-end connector 30D shown in FIG. 14. As shown, the contact portions 332D of the power terminals 33D of the board-end connector 30D are exposed in the slot 39 of the insulative housing 31D and extend towards the mating direction K1. The leg portion 331D of the power terminal 33D extends along a direction different from the extending direction of the contact portion 332D. For example, the leg portion 331D can be generally normal to the circuit board 96 (also see FIG. 14). In other words, the leg portion 331D can extend in a direction normal to the mating direction K1. The middle portion 333D of the power terminal 33D is connected between the leg portion 331D and the contact portion 332D and is bent into an arc. The detection terminal 32D of the board-end connector 30D may include a leg portion 321D, a contact portion 322D and a middle portion 323D forming an L-shaped structure. In addition, the insulative housing 31D of the board-end connector 30D may include some or all of the structural features of the insulative housing 31 described above. For example, the insulative housing 31D may include the slot 39, the guiding strip 40, the hook 43, the detection terminal channels 45, the power terminal channels 46, and etc.

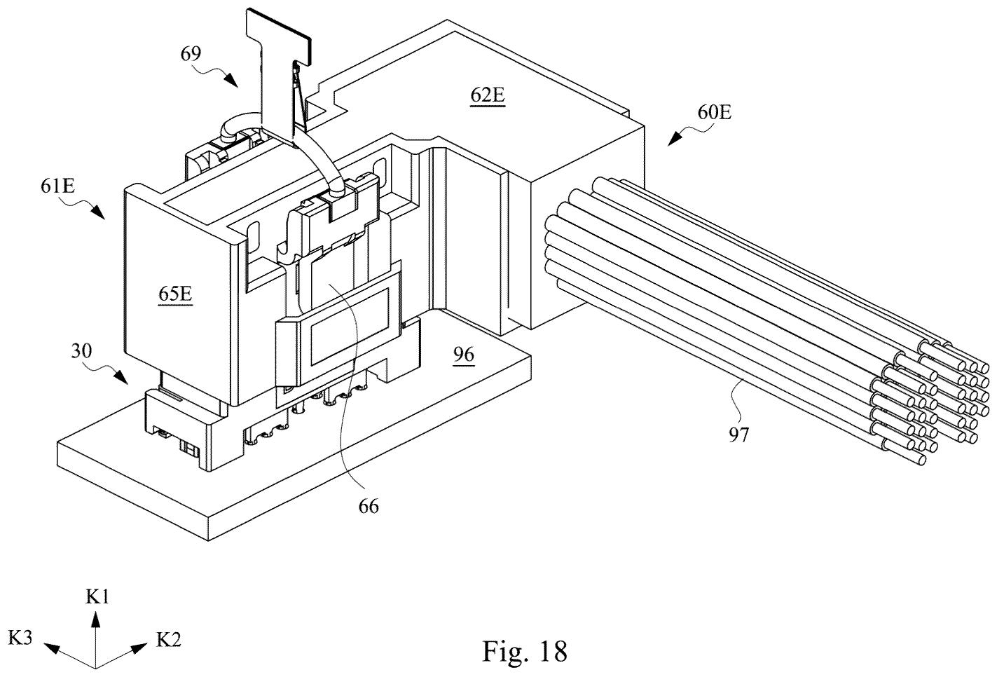

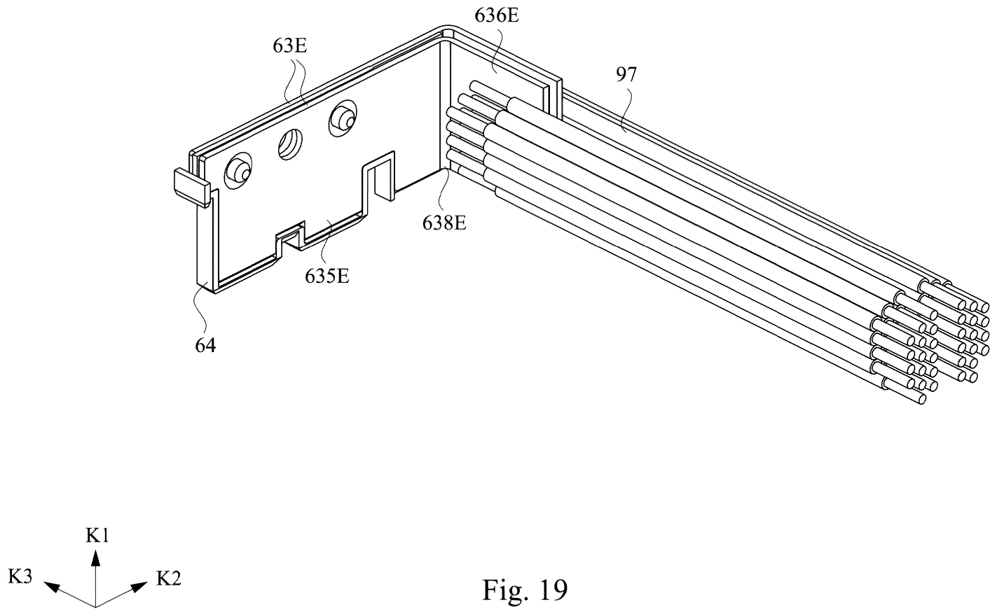

Reference is made to FIGS. 18 and 19. FIG. 18 illustrates an axonometric view of a power connector assembly in accordance with another embodiment of the present disclosure. FIG. 19 illustrates an axonometric view of some components of the cable-end connector 60E shown in FIG. 18. The cable-end connector 60E of the present embodiment differs from the cable-end connector 60 described above in that the cable connection portion 636E and the contact portion 635E of the cable-end terminal 63E extend in different directions. For example, the contact portion 635E can extend along the second direction K2, and the cable connection portion 636E can extend along the third direction K3, therefore forming L-shaped cable-end terminal 63E. Each cable-end terminal 63E further includes a middle portion 638E, which is connected between a lateral edge of the contact portion 635E and a lateral edge of the cable connection portion 636E and is bent into an arc. The inner mold 62E and the main body 65E of the insulative housing 61E also have bent shapes corresponding to the cable-end terminals 63. The cable assembly 97 extends out of the insulative housing 61E along the third direction K3.

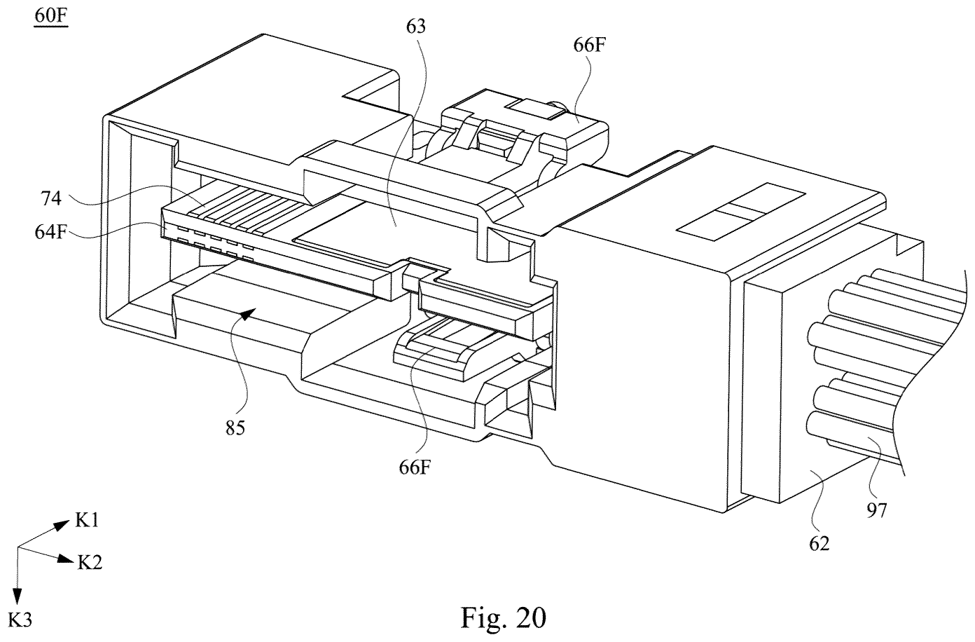

Reference is made to FIG. 20, which illustrates an axonometric view of a cable-end connector 60F in accordance with another embodiment of the present disclosure. Compared to the embodiments described above, the mating member of the cable-end connector 60F of the present embodiment further includes a plurality of first signal terminals 74. The first signal terminals 74 are electrically connected to the cable assembly 97 and are configured to transmit electronic signal. In the present embodiment, the first signal terminals 74 are disposed on a side of the mating member away from the cable assembly 97, while the cable-end terminals 63 are disposed close to the cable assembly 97. The terminal spacer 64F of the mating member has an extension region. The extension region is located on a side of the terminal spacer 64F away from the cable assembly 97.

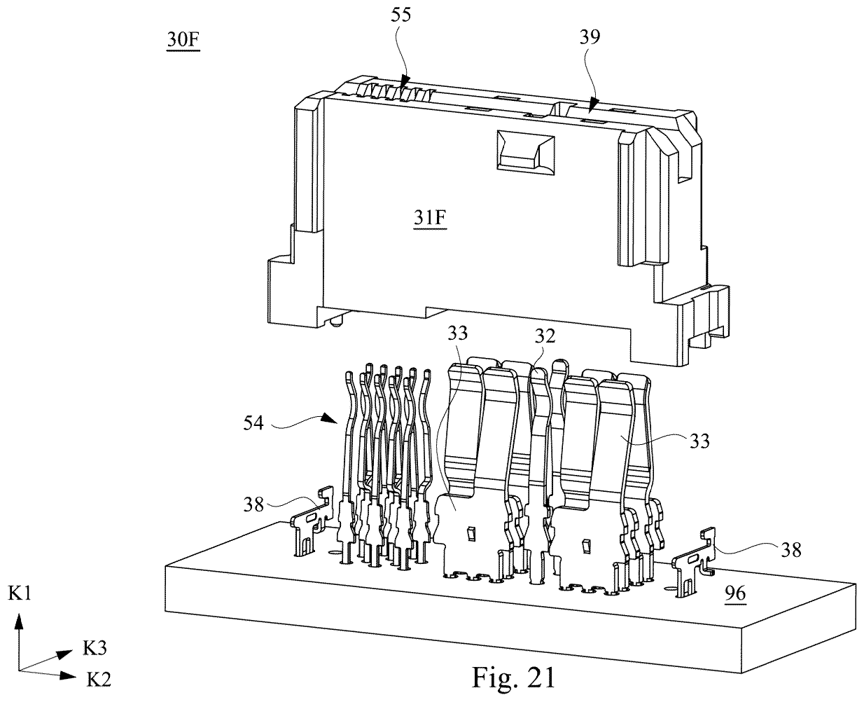

The first signal terminals 74 are disposed in the extension region of the terminal spacer 64F and are linearly arranged along the second direction K2. The first signal terminals 74 can be provided on two faces of the terminal spacer 64F. In some embodiments, the first signal terminals 74 can be positioned nearby the cable assembly 97, or can be positioned between multiples sets of cable-end terminals. The first signal terminals 74 include contact portions that are exposed at the surfaces of the terminal spacer 64F and may be flushed with the surfaces of the terminal spacer 64F. Foremost parts of the first signal terminals 74 can be fixed within the terminal spacer 64F. Two latches 66 are provided on outer sides of the cable-end terminals 63. Since the force required to plug or unplug the first signal terminals 74 and the force required to plug or unplug the cable-end terminals 63 are different, in the second direction K2, a center line of each latch 66F and a center line of the mating chamber 85 are misaligned to compensate for difference in the plugging or unplugging force mentioned above. In other words, the latches 66F at an offset from the center line of the mating chamber 85. Hence, when separating the cable-end connector 60F from the corresponding board-end connector (e.g., the board-end connector 30F shown in FIG. 21), the difference in the plugging or unplugging force and the moment created by the latches 66 can reach a substantial balance.

Reference is made to FIG. 21, which illustrates an exploded view of a board-end connector 30F in accordance with another embodiment of the present disclosure, in which the board-end connector 30F can mate with the cable-end connector 60F shown in FIG. 20. As shown, the board-end connector 30F includes a plurality of second signal terminals 54 configured to make contact with the first signal terminals 74 of the cable-end connector 60F. The second signal terminals 54 are mounted upright on the circuit board 96 and are located on one side of the detection terminals 32 and the power terminals 33. The second signal terminals 54 can be arranged into two rows in the second direction K2. The two rows of second signal terminals 54 are disposed on two sides of the slot 39 of the insulative housing 31F, respectively. The second signal terminals 54 may be structurally similar to the detection terminals 32. For example, the second signal terminals 54 can each include a leg portion, a contact portion, etc., as mentioned above. Each of the second signal terminals 54 may have a contact region lower than the contact regions of the power terminals 33. The insulative housing 31F may have a plurality of signal terminal channels 55 accommodating the second signal terminals 54. Each of the second signal terminals 54 is disposed inside one of the signal terminal channels 55. The signal terminal channels 55 may be structurally similar to the detection terminal channels 45 mentioned above. The first signal terminals 74 and the second signal terminals 54 may be used to transmit low-frequency signals. In some embodiments, at least one of the second signal terminals 54 can act as a detection terminal that serves to generate the detection signal. In such embodiments, the detection terminal 32 can be omitted.

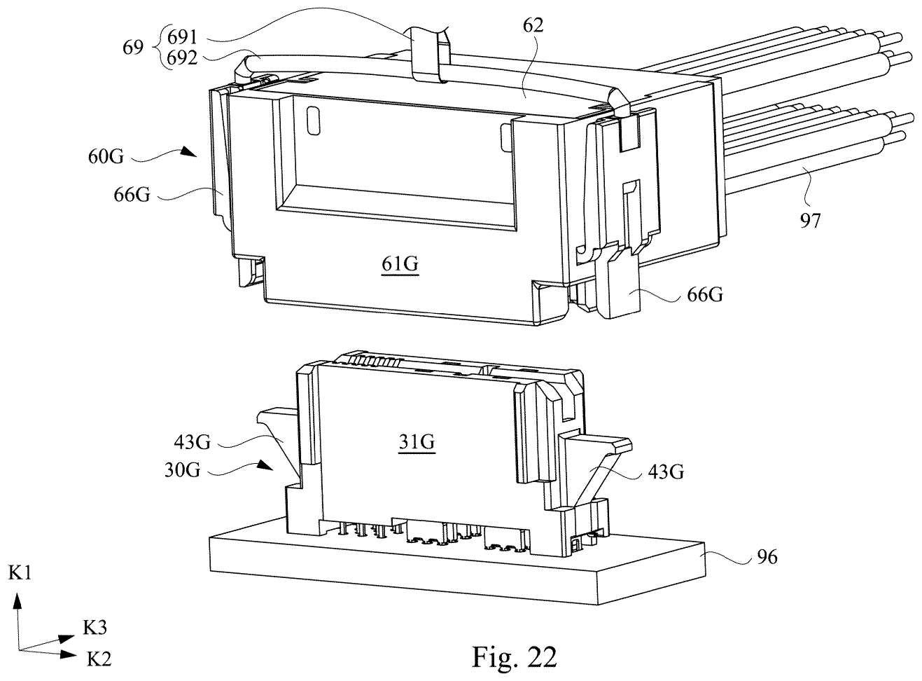

Reference is made to FIG. 22, which illustrates an exploded view of a power connector assembly in accordance with another embodiment of the present disclosure. The power connector assembly of the present embodiment includes a board-end connector 30G and a cable-end connector 60G. Contrary to the embodiments described above, the cable-end connector 60G of the present embodiment includes two latches 66G that are disposed on two short sides of the insulative housing 61G and are arranged along the second direction K2. Correspondingly, the insulative housing 31G of the board-end connector 30G includes two hooks 43G that are disposed on two short sides of the insulative housing 31G, below two side openings on two lateral surfaces of the insulative housing 31G, and are arranged along the second direction K2. Each latch 66G is configured to interlock with one of the hooks 43G. The interconnection component 692 of the unlocking device 69 extends across the insulative housing 61G in the second direction K2, and two ends of the interconnection component 692 are connected to the two latches 66G, respectively.

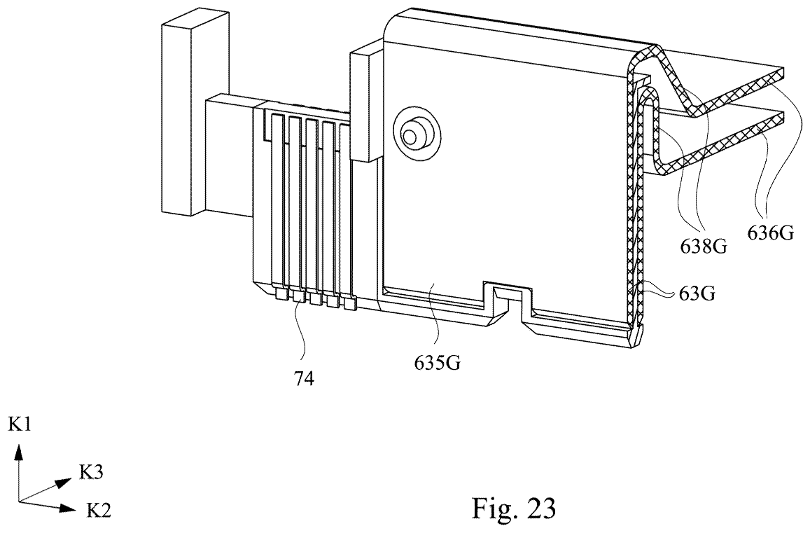

Reference is made to FIG. 23, which illustrates a sectional view of some components of the cable-end connector 60G shown in FIG. 22. The cable-end connector 60G of the present embodiment is a side-exit type connector. The cable connection portion 636G of the cable-end terminal 63G is substantially normal to the contact portion 635G. Each cable-end terminal 63G further includes a middle portion 638G connected between an upper edge of the contact portion 635G and the cable connection portion 636G. In some embodiments, the middle portion 638G includes a folded structure. In some embodiments, the middle portion 638G includes a sloping structure.

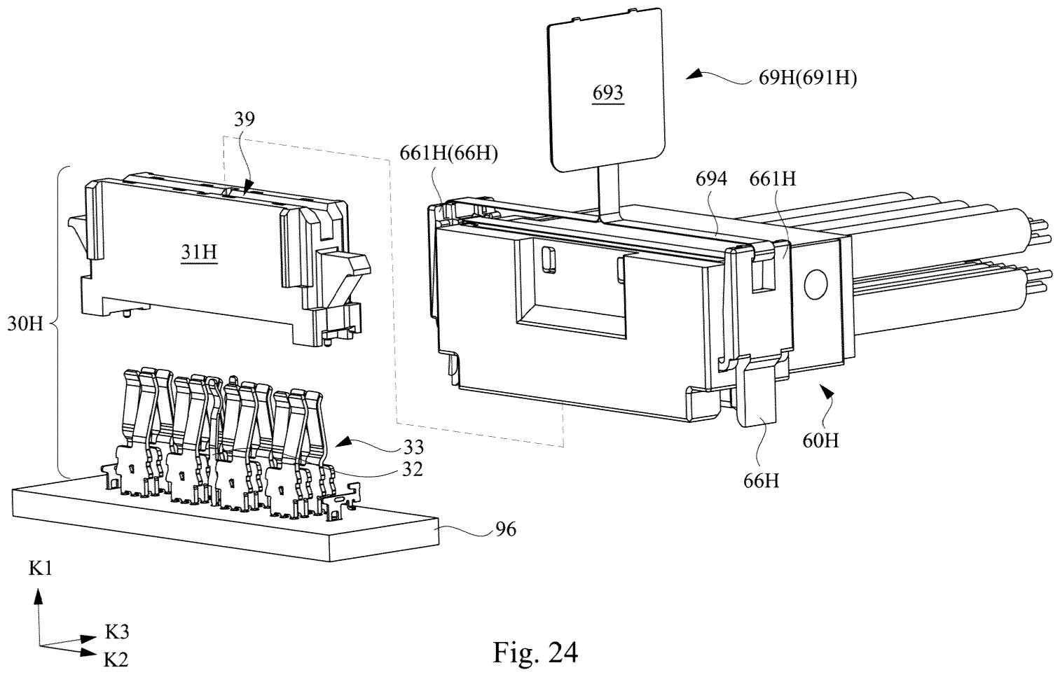

Reference is made to FIG. 24, which illustrates an exploded view of a power connector assembly in accordance with another embodiment of the present disclosure. The power connector assembly of the present embodiment includes a board-end connector 30H and a cable-end connector 60H. Unlike the embodiments described above, in the present embodiment, the two groups of terminals of the board-end connector 30H (each group disposed on one side of the slot 39 of the insulative housing 31H) each include four sets of power terminals 33 to enable transmission of larger electric current. The detection terminal 32 is disposed in the middle of each group, such that the two sides of the detection terminal 32 each have two sets of power terminals 33. Furthermore, the unlocking device 69H includes a pull tape 691H. The pull tape 691H includes an operation section 693 and an interconnection section 694 connected to the operation section 693. The interconnection section 694 has a closed shape and slidably extends through the operation portions 661H of the two latches 66H. In some embodiments, the operation portion 661H has a through hole. When the user pulls the operation section 693 of the pull tape 691H in a direction away from the board-end connector 30H, the interconnection section 694 brings the operation portions 661H of the two latches 66H closer together to unlock the connectors.

In sum, by virtue of the structural configurations described above, the power connector and the power connector assembly of the present disclosure can carry larger electric current and provide stable power supply, while maintaining a compact size.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A power connector assembly, comprising:
a first power connector comprising a first insulative housing, at least one detection terminal and a plurality of power terminals, wherein the first insulative housing has a slot, the power terminals are divided into two sets disposed on two sides of the slot, respectively, each of the power terminals comprises at least one elastic arm exposed in the slot, and the at least one detection terminal is disposed on at least one of the two sides of the slot; and
a second power connector comprising a second insulative housing, a cable assembly and a mating member, wherein the mating member comprises two cable-end terminals provided on two faces of the mating member, respectively, and electrically isolated from each other, the second insulative housing has a mating chamber configured to receive the first power connector, the mating member is located in the mating chamber and is configured to be inserted into the slot of the first power connector and make contact with the at least one detection terminal and the power terminals of the first power connector, and the cable assembly is electrically connected to the mating member and extends out of the second insulative housing.

2. The power connector assembly of claim 1, wherein each of the power terminals comprises a leg portion, the leg portion comprises a plurality of tails, and the tails of the power terminals of each of the two sets are arranged into multiple rows.

3. The power connector assembly of claim 1, wherein the first insulative housing has a mating portion configured to be inserted into the mating chamber, a lateral surface of the mating portion is provided with a guiding strip, the guiding strip extends along a mating direction of the first power connector and the second power connector, and wherein the second insulative housing has a guiding groove configured to receive the guiding strip.

4. The power connector assembly of claim 1, wherein a front edge of the mating member has a notch, and the notch is at a position corresponding to the at least one detection terminal.

5. The power connector assembly of claim 1, wherein the mating member further comprises a terminal spacer disposed between the two cable-end terminals.

6. The power connector assembly of claim 5, wherein the terminal spacer comprises a projecting rim covering front edges of the two cable-end terminals, and the projecting rim has at least one chamfer.

7. The power connector assembly of claim 1, wherein the second insulative housing comprises a main body and a latch, the main body has the mating chamber, the latch is disposed on a side of the mating chamber and is configured to interlock with the first insulative housing.

8. The power connector assembly of claim 7, wherein the second power connector further comprises a pull tape connected to the latch.

9. The power connector assembly of claim 7, wherein the main body further has a side opening communicating with the mating chamber, the latch is positioned to face the side opening, and wherein the main body further comprises a guarding wall partially covering the side opening and the latch.

10. The power connector assembly of claim 1, wherein the power terminals comprise a first power terminal and a second power terminal each having a contact region, the contact region is located on the at least one elastic arm, and the contact region of the first power terminal and the contact region of the second power terminal are substantially coplanar.

11. The power connector assembly of claim 1, wherein the at least one detection terminal has a first contact region, each of the power terminals has a second contact region, and a distance from the first contact region to an entrance of the slot is greater than a distance from the second contact region to the entrance of the slot.

12. A power connector, comprising:
an insulative housing having a slot; and
a plurality of terminals disposed in the insulative housing and partially exposed in the slot, the terminals comprising at least one detection terminal and a plurality of power terminals, wherein each of the power terminals comprises a leg portion, the leg portion comprises a plurality of tails, the power terminals are divided into multiple power terminal sets, and for each power terminal set, the tails of the power terminals are arranged into multiple rows.

13. The power connector of claim 12, wherein the insulative housing comprises a base portion and a mating portion, the mating portion has the slot and a guiding strip, and the guiding strip is provided on a lateral surface of the mating portion and extends along a mating direction.

14. The power connector of claim 12, wherein each of the power terminals comprises at least one elastic arm, the power terminals comprise a first power terminal and a second power terminal each having a contact region, the contact region is located on the at least one elastic arm, the contact region of the first power terminal and the contact region of the second power terminal are substantially coplanar, and the contact region of the first power terminal and the contact region of the second power terminal are at different heights in a mating direction of the power connector.

15. The power connector of claim 12, wherein the at least one detection terminal has a first contact region, each of the power terminals has a second contact region, and a distance from the first contact region to an entrance of the slot is greater than a distance from the second contact region to the entrance of the slot.

16. A power connector, comprising:
an insulative housing having a mating chamber for receiving another power connector;
a mating member comprising two cable-end terminals, the two cable-end terminals each comprising a contact portion and a cable connection portion, wherein the contact portions of the two cable-end terminals are substantially planar, located in the mating chamber, and provided on two faces of the mating member, respectively; and
a cable assembly connected to the cable connection portion of the two cable-end terminals and extends out of the insulative housing.

17. The power connector of claim 16, wherein a front edge of the mating member has a notch in the mating chamber.

18. The power connector of claim 16, wherein the mating member further comprises a terminal spacer disposed between the two cable-end terminals and comprising a projecting rim, and the projecting rim covers front edges of the two cable-end terminals.

19. The power connector of claim 16, wherein the insulative housing comprises a main body and a latch, the main body has the mating chamber, and the latch is rotatably disposed on a side of the mating chamber.

20. The power connector of claim 19, wherein the main body further has a side opening communicating with the mating chamber, the latch is positioned to face the side opening, and wherein the main body further comprises a guarding wall partially covering the side opening and the latch.
